(19) United States
(12) Patent Application Publication
(10) Pub. No.: US 2016/0318106 A1
(43) Pub. Date: Nov. 3, 2016

(54) DRILL CHUCK FOR PREVENTING OVER-POSITION OPERATION

(71) Applicant: ZHEJIANG SANOU MACHINERY CO. LTD., Zhejiang (CN)

(72) Inventors: Wenhua ZHOU, Zhejiang (CN); Yanxing XU, Zhejiang (CN)

(21) Appl. No.: 15/107,760

(22) PCT Filed: Jun. 3, 2015
(86) PCT No.: PCT/CN2015/080671

§ 371 Date: Jun. 23, 2016

(30) Foreign Application Priority Data
Jun. 3, 2014 (CN) 201420293198.2

(51) Int. Cl. B23B 31/12

(52) U.S. Cl. CPC B23B 31/1238; B23B 31/123; B23B 2260/136

(57) ABSTRACT

The present invention provides a drill chuck for preventing over-position operation, a drill body thereof is provided with an elastic switch part; the elastic switch part is matched up with the stepped surface in front of a clamping jaw thread, and can be pressed down under the action of the stepped surface when the clamping jaw retreats to and is close to a limit and can automatically upwarp and reset during being released; at the front end of the nut there is provided with a protrusion matching up with the elastic switch part, the protrusion can be in contact with the pressed elastic switch part during rotating with the nut, thereby forming a stop fit. The drill chuck play the role of switching operation through the self motion of the clamping jaw, and when the clamping jaw retreats to the bottom, the elastic switch part is pressed down by the clamping jaw and is matched up with the protrusion on the nut to limit nut to further rotate, thereby preventing operation over-position and having a protective effect on the drill chuck; in addition, the present invention is simple in structure, and is very convenient for manufacturing and assembling.

### FIELD OF THE INVENTION

The present invention relates to a drill chuck.

### BACKGROUND OF THE INVENTION

In the prior art, a drill body, a clamping jaw and a nut are arranged in a drill chuck, and the drill chuck is enabled to clamp or loosen a drilling tool by turning the nut to drive the clamping jaw to move forward or backward. However, when the clamping jaw retreats to the bottom, threads may be locked because operation over-position causes retreating beyond a limit. Great force is needed when the nut needs to be turned to drive the clamping jaw to move forward, and if the drill chuck has a self-locking function, a self-locking structure may be damaged.

### SUMMARY OF THE INVENTION

The technical problem to be solved by the present invention is to provide a drill chuck for preventing over-position operation, which is capable of protecting the drill chuck when the clamping jaw retreats to the bottom. Therefore, the present invention adopts the technical scheme as follows:

A drill chuck for preventing over-position operation, includes a drill body, a clamping jaw and a nut, where the nut is connected with a clamping jaw thread, and the clamping jaw is driven by the nut to move forward or backward; the drill body is provided with an elastic switch part which matches up with a stepped surface in front of a clamping jaw thread, the elastic switch part can be pressed down under the action of the stepped surface when the clamping jaw retreats to and is close to a limit and can automatically upwarp and reset when the clamping jaw is released. At the front end of the nut there is provided with a protrusion matching up with the elastic switch part, the protrusion can be in contact with the pressed elastic switch part during rotating with the nut, thereby forming a stop fit.

On the basis of the aforesaid technical scheme, the present invention may further adopt the technical scheme as follows:

The elastic switch part is provided with a connecting end which is connected with a position in front of a nut mounting groove positioned on the drill body.

The drill chuck is provided with a split elastic component having a connecting end connected to the position in front of the nut mounting groove positioned on the drill body; an inner fork of the split elastic component is the elastic switch part, and an outer fork thereof is on the nut.

In a position in front of the nut mounting groove of the drill body there is provided with a step for containing the elastic component, and the step and the front end of the nut form space for containing the elastic component.

The elastic switch part is a circular-arc-shaped spring leaf whose external diameter is smaller than the internal diameter of the nut, and thus can be pressed into the nut by the stepped surface. The elastic switch part is a spring left or a line spring.

As the technical scheme of the present invention is adopted, the present invention can play a role of switch operation through the self motion of the clamping jaw. When the clamping jaw retreats to the bottom, the elastic switch part is pressed down by the clamping jaw and is matched up with the protrusion on the nut to limit the nut to further rotate, thereby preventing operation over-position and having a protective effect on the drill chuck; in addition, the present invention is simple in structure, and is very convenient for manufacturing and assembling.

### BRIEF DESCRIPTION OF THE DRAWINGS

FIG. 1 is a half-sectional view of an embodiment provided by the present invention;

FIG. 2 is an overall exploded view of an embodiment provided by the present invention;

FIG. 3 is a schematic diagram of the drill body according to an embodiment of the present invention;

FIG. 4 is a schematic structural diagram of a nut according to an embodiment of the present invention;

FIG. 5 is schematic structural diagram of an elastic component according to an embodiment of the present invention;

FIG. 6 is a schematic diagram of a clamping jaw according to an embodiment of the present invention;

FIG. 7 is a schematic diagram showing the operation fit among the clamping jaw, the nut and the elastic component; and

FIG. 8 is a schematic diagram showing the operation fit among the clamping jaw, the nut and the elastic component, with the drill body being hidden.

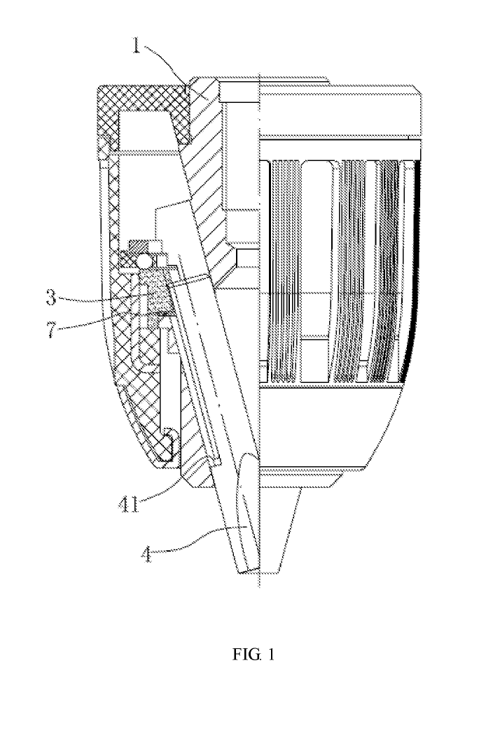

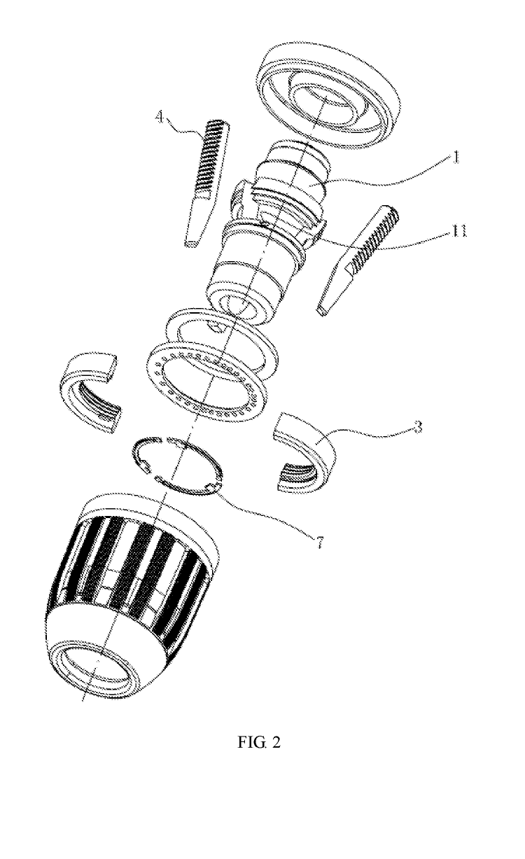

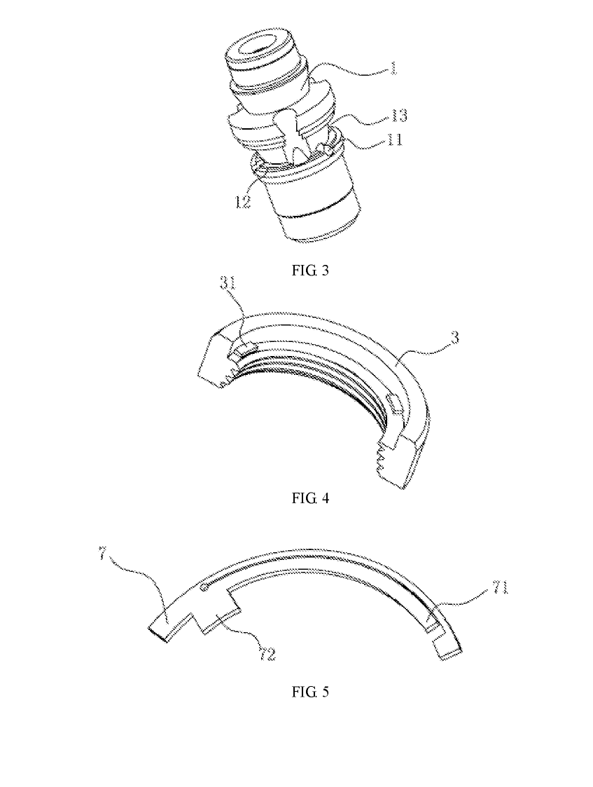

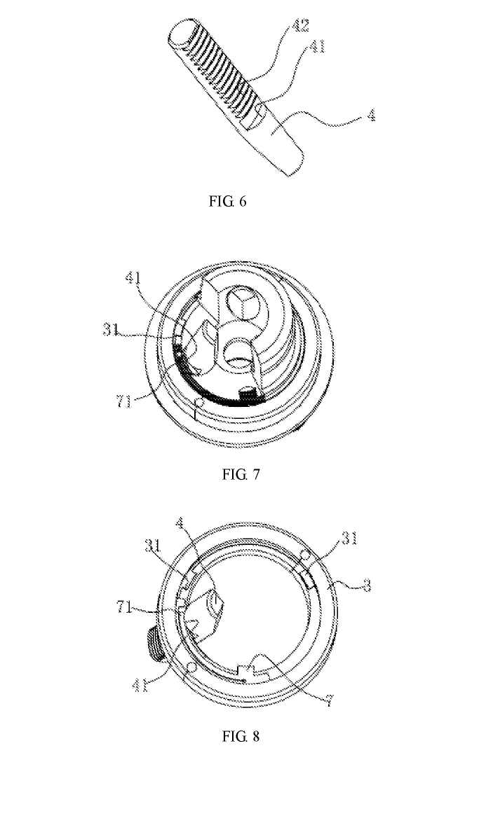

### DETAILED DESCRIPTION OF THE EMBODIMENTS

Referring to drawings, a drill chuck for preventing over-position operation provided by the present invention includes a drill body 1, a clamping jaw 4 and a nut 3, where the nut 3 is connected with a clamping jaw 4 thread; the clamping jaw 4 is driven by the nut 3 to move forward and backward; the drill body 1 is provided with an elastic switch part 71; the elastic switch part 71 is matched up with a stepped surface 41 in front of a clamping jaw thread 42, and can be pressed down under the action (the stepped surface will exert force to the elastic switch part 71 when the clamping jaw 4 retreats to the bottom) of the stepped surface 41 when the clamping jaw 4 retreats to and is close to a limit, and can automatically upwarp and reset when the stepped surface 41 moves upward and thus the clamping jaw 4 is released; at the front end of the nut there is provided with a protrusion 31 matching up with the elastic switch part; the protrusion 31 can be in contact with the pressed elastic switch part during rotating with the nut, so as to form a stop fit. The stop fit is immediately relieved after the elastic switch part 71 automatically upwarps and resets. The protrusion 31 can be a part formed by processing the nut 3, or be an independent component fixedly mounted on the nut 3.

The drill chuck is provided with a split elastic component 7 having a connecting end 72 connected to a position in front of a nut mounting groove 13 positioned on the drill body. The drill body has a corresponding connecting hole 11; an inner fork of the elastic component 7 is the elastic switch part 71, and an outer fork 73 is on the nut and has a stabilizing effect.

The drill body is provided, in a position in front of the nut mounting groove, with a step 12 for containing the elastic component, and space for containing the elastic component 7 is formed between the step 12 and the front end of the nut 3.

The elastic switch part 71 is a circular-arc-shaped spring leaf whose external diameter is smaller than the internal diameter of the nut 3, and thus can be pressed into the nut 3 by a stepped surface 41.

The elastic switch part 71 is a spring leaf or a line spring.

1. A drill chuck for preventing over-position operation, comprising a drill body, a clamping jaw and a nut, wherein the nut is connected with a clamping jaw thread, and the nut drives the clamping jaw to move forward or backward; the drill chuck is characterized in that the drill body is provided with an elastic switch part; the elastic switch part is matched up with a stepped surface in front of the clamping jaw thread, can be pressed down under the action of the stepped surface when the clamping jaw retreats to and is close to a limit, and can automatically upwarp and reset when the clamping jaw is released; at the front end of the nut there is provided with a protrusion matching up with the elastic switch part, the protrusion can be in contact with the pressed elastic switch part during rotating with the nut, so as to form a stop fit.

2. The drill chuck for preventing over-position operation according to claim 1, wherein, the elastic switch part is provided with a connecting end connected with a position in front of a nut mounting groove on the drill body.

3. The drill chuck for preventing over-position operation according to claim 1, wherein, the drill chuck is provided with a split elastic component having a connecting end connected to a position in front of a nut mounting groove positioned on the drill body; an inner fork of the split elastic component is the elastic switch part, and an outer fork thereof is on the nut.

4. The drill chuck for preventing over-position operation according to claim 3, wherein, in a position in front of the nut mounting groove of the drill body there is provided with a step for containing the elastic component, and the step and a front end of the nut form space for containing the elastic component.

5. The drill chuck for preventing over-position operation according to claim 1, wherein, the elastic switch part is a circular-arc-shaped spring leaf whose external diameter is smaller than an internal diameter of the nut, and thus can be pressed into the nut by the stepped surface.

6. The drill chuck for preventing over-position operation according to claim 2, wherein, the elastic switch part is a circular-arc-shaped spring leaf whose external diameter is smaller than an internal diameter of the nut, and thus can be pressed into the nut by the stepped surface.

7. The drill chuck for preventing over-position operation according to claim 3, wherein, the elastic switch part is a circular-arc-shaped spring leaf whose external diameter is smaller than an internal diameter of the nut, and thus can be pressed into the nut by the stepped surface.

8. The drill chuck for preventing over-position operation according to claim 1, wherein, the elastic switch part is a spring leaf or a line spring.

9. The drill chuck for preventing over-position operation according to claim 2, wherein, the elastic switch part is a spring leaf or a line spring.

10. The drill chuck for preventing over-position operation according to claim 3, wherein, the elastic switch part is a spring leaf or a line spring.
